(19) United States
(12) Patent Application Publication
(10) Pub. No.: US 2011/0217579 A1
(43) Pub. Date: Sep. 8, 2011

(54) ALKALINE BATTERY

(76) Inventors: Harunari Shimamura, Osaka (JP); Jun Nunome, Kyoto (JP); Fumio Kato, Osaka (JP)

(21) Appl. No.: 13/127,891

(22) PCT Filed: Oct. 22, 2009
(86) PCT No.: PCT/JP2009/005553

§ 371 Date: May 5, 2011

(30) Foreign Application Priority Data
Nov. 25, 2008 (JP) 2008-299477

(51) Int. Cl. H01M 6/10

(52) U.S. Cl. 429/94

(57) ABSTRACT

A negative electrode (6) of an alkaline battery is a wound porous sheet containing zinc, and includes a hollow part (6a). A main body (21) of a negative electrode current collector (20) is disposed in the hollow part (6a). A retainer (22) of the negative electrode current collector (20) is disposed between portions of the negative electrode (6) which are adjacent to each other in the radial direction of the negative electrode (6). The retainer (22) is connected to the main body (21) outside the negative electrode (6). The main body (21) and the retainer (22) of the negative electrode current collector (20) sandwich a portion of the negative electrode (6) which is present between the main body (21) and the retainer (22).

### TECHNICAL FIELD

The present invention relates to alkaline batteries.

### BACKGROUND ART

Alkaline batteries including manganese dioxide as a positive electrode active material, zinc as a negative electrode active material, and an alkaline solution as an electrolyte have widely been used as power sources of various devices for their versatility and inexpensiveness. Such an alkaline battery generally has a negative electrode for which irregular-shape zinc powder obtained by, for example, gas atomization is used.

PATENT DOCUMENT 1 discloses a negative electrode made of porous solid zinc (made of wooly (flocculate) zinc fibers). PATENT DOCUMENT 1 describes that when the porous solid zinc is used, the contact resistance between negative electrode active materials can be reduced compared to the case where the irregular-shape zinc powder is used, so that it is possible to improve discharge characteristics.

PATENT DOCUMENT 1 further discloses a current collecting method in which a negative electrode is made of the porous solid zinc, wherein the method of compressing a sheet made of wooly zinc to form, for example, a grid or tab (current collector) is disclosed.

### Citation List

### Patent Document

PATENT DOCUMENT 1: Japanese Translation of PCT International Application No. 2008-518408

### SUMMARY OF THE INVENTION

### Technical Problem

However, the current collecting method disclosed in PATENT DOCUMENT 1 has the following problems.

When the current collecting method disclosed in PATENT DOCUMENT 1 is used to produce a cylindrical battery, a sealing plate has to be welded to the grid or tab. It is generally known that in welding, a spark produces sputtered substances (foreign materials). When sputtered substances are produced during welding the sealing plate to the grid or tab, the sputtered substances (here, metal flakes) may enter a positive electrode or the negative electrode. When the metal flakes enter the positive electrode or the negative electrode, the metal flakes dissolves in an alkaline electrolyte, which generates gas, so that leakage of the alkaline electrolyte is caused. As described above, using the current collecting method disclosed in PATENT DOCUMENT 1 to produce a cylindrical battery poses a problem that leakage of the alkaline electrolyte is caused because the sealing plate has to be welded to the grid or tab.

On the other hand, a conventional alkaline battery has a nail-shaped negative electrode current collector inserted into a through hole of a sealing plate, and thus the negative electrode current collector is not welded to the sealing plate in producing the conventional alkaline battery. Thus, when a nail-shaped current collector used in the conventional alkaline battery is used as a negative electrode current collector, the problem can probably be solved. However, when the sheet made of zinc disclosed in PATENT DOCUMENT 1 is used as a negative electrode, and the conventional nail-shaped current collector is used as a negative electrode current collector, the following new problems occur.

In a negative electrode of an alkaline battery, a discharge reaction proceeds from a rim in the radial direction toward the center of the negative electrode, and zinc (Zn) is oxidized to zinc oxide (ZnO) due to discharge. It is generally known that when zinc is oxidized to zinc oxide, the volume the zinc oxide is about 1.2 times that of the zinc. Thus, discharging the alkaline battery causes expansion of the rim in the radial direction of the negative electrode. The expansion causes stress inside the negative electrode, and the occurrence of the stress lowers the degree of contact between the nail-shaped negative electrode current collector and the negative electrode, so that current collection performance at the negative electrode is degraded. The occurrence of the stress becomes significant at the end stage of discharge, and thus the current collection performance is significantly degraded at the end stage of discharge, so that satisfactory discharge performance cannot be obtained. As described above, using the sheet made of zinc disclosed in PATENT DOCUMENT 1 as the negative electrode, and the conventional nail-shaped current collector as the negative electrode current collector poses a problem that the discharge performance is degraded.

In view of the foregoing, it is an object of the present invention to reduce degradation in discharge performance when a wound porous sheet containing zinc is used as a negative electrode.

### Solution to the Problem

First to fourth alkaline batteries of the present invention each includes a positive electrode in a battery case, a negative electrode inside the positive electrode, a separator between the positive electrode and the negative electrode, a negative electrode current collector, and an alkaline electrolyte.

In the first alkaline battery of the present invention, the negative electrode is a wound porous sheet containing zinc, and has a hollow part extending in the longitudinal direction of the battery case. The negative electrode current collector includes a main body in the shape of a rod, and a retainer. The main body is disposed in the hollow part such that the axial direction of the main body is parallel to the longitudinal direction of the hollow part. The retainer is disposed between portions of the negative electrode which are adjacent to each other in the radial direction of the negative electrode. The retainer is connected to the main body. The main body and the retainer sandwich a portion of the negative electrode which is present between the main body and the retainer.

Here, specific examples of the “porous sheet containing zinc” includes a porous sheet made of zinc, a porous sheet made of a zinc alloy, or a porous sheet which is made of zinc or a zinc alloy, and is provided with metal other than zinc (except for mercury).

Moreover, “between portions of the negative electrode which are adjacent to each other in the radial direction of the negative electrode” indicates a position between an nth winding and an (n+1)th winding of the negative electrode, where n is an integer greater than or equal to 1.

In the alkaline battery with this configuration, even when the negative electrode is deformed due to discharge, contact between the negative electrode and the negative electrode current collector can be maintained.

In the first alkaline battery of the present invention, the negative electrode current collector includes a pressure contact part at which the retainer is pressure contacted to the main body. In the alkaline battery with this configuration, the main body and the retainer of the negative electrode current collector hold, at the pressure contact part, a portion of the negative electrode which is present between the main body and the retainer.

In the first alkaline battery of the present invention, the retainer is preferably disposed between an innermost circumference portion and a next innermost circumference portion of the negative electrode, and the main body and the retainer preferably sandwich end part of the innermost circumference portion in the circumferential direction of the negative electrode. In the alkaline battery with this configuration, the main body and the retainer of the negative electrode current collector can easily sandwich a portion of the negative electrode which is present between the main body and the retainer.

In the second alkaline battery of the present invention, the negative electrode is a wound porous sheet containing zinc, and has a hollow part extending in the longitudinal direction of the battery case. The negative electrode current collector includes a main body in the shape of a rod, and an inclined member. The main body is disposed in the hollow part such that the axial direction of the main body is parallel to the longitudinal direction of the hollow part. The inclined member is inclined relative to the axial direction of the main body, one end of the inclined member is connected to the main body, and the other end of the inclined member is disposed in the negative electrode. In the alkaline battery with this configuration, even when the negative electrode is deformed due to discharge, contact between the negative electrode and the negative electrode current collector can be maintained.

In the second alkaline battery of the present invention, the inclined member of the negative electrode current collector preferably includes two or more and seven or less inclined members. In the alkaline battery with this configuration, the negative electrode current collector can relatively easily be formed.

In the third alkaline battery of the present invention, the negative electrode is a wound porous sheet containing zinc, and has a hollow part extending in the longitudinal direction of the battery case. The negative electrode current collector includes a main body which is in the shape of a rod, and has a side surface provided with a raised/recessed part. The negative electrode current collector is disposed in the hollow part such that the axial direction of the main body is parallel to the longitudinal direction of the hollow part. Here, the raised/recessed part is formed in a helical pattern relative to the axial direction of the main body in preferable embodiments below. In the alkaline battery with this configuration, the contact area between the negative electrode and the negative electrode current collector can be large compared to the case where the raised/recessed part is not formed on the side surface of the negative electrode current collector. Thus, even when the negative electrode is deformed due to discharge, connection between the negative electrode and the negative electrode current collector can be maintained.

In the fourth alkaline battery of the present invention, the negative electrode is a wound porous sheet containing zinc. The negative electrode current collector includes a cover plate covering one end surface of the negative electrode, and a pressure member pressing the cover plate against the end surface of the negative electrode via a spring body. In the alkaline battery with this configuration, even when the negative electrode is deformed due to discharge, connection between the negative electrode and the negative electrode current collector can be maintained.

In the fourth alkaline battery of the present invention, the spring body is preferably a disc spring having an outer diameter that decreases toward the cover plate. In the alkaline battery with this configuration, the cover plate can easily be pressed against one end surface of the negative electrode compared to the case where the spring body has an outer diameter increasing toward the cover plate, or to the case where the spring body has a uniform outer diameter in a direction to the cover plate.

In the first to fourth alkaline batteries of the present invention, it is preferable that 1.0≦x/y≦1.5, where the total mass of the alkaline electrolyte in the battery case is x [g], and the mass of the zinc in the negative electrode is y [g]. Here, “total mass of the alkaline electrolyte in the battery case” includes the mass of the alkaline electrolyte in the positive electrode, the negative electrode, and the separator. In the alkaline battery with this configuration, the amount of the alkaline electrolyte in the battery case can be increased compared to a commercially available conventional alkaline battery (x/y is less than 1.0).

In the first to fourth alkaline battery of the present invention, the positive electrode contains manganese dioxide as an active material, and it is preferable that 0.9≦(capacity of the negative electrode/capacity of the positive electrode)≦1.1, where the capacity of the positive electrode is calculated on a condition that the manganese dioxide has a theoretical capacity of 308 mAh/g, and the capacity of the negative electrode is calculated on a condition that the zinc has a theoretical capacity of 820 mAh/g. In the alkaline battery with this configuration, the amount of the positive electrode active material filled in the battery case can be increased compared to a commercially available conventional alkaline battery ((capacity of the negative electrode/capacity of the positive electrode) is greater than 1.1).

### ADVANTAGES OF THE INVENTION

In the present invention, degradation in discharge performance when a wound porous sheet containing zinc is used as a negative electrode can be reduced.

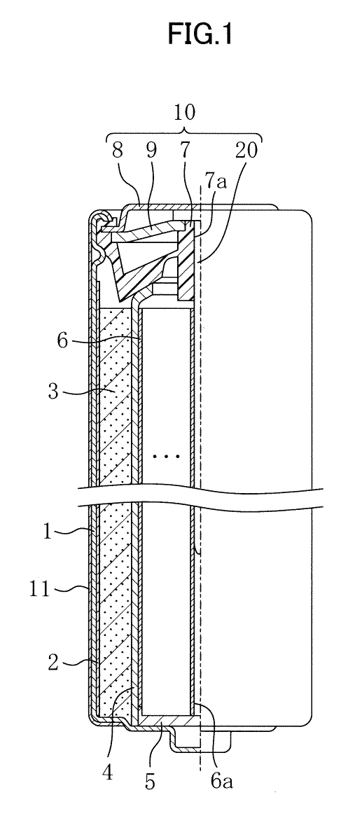

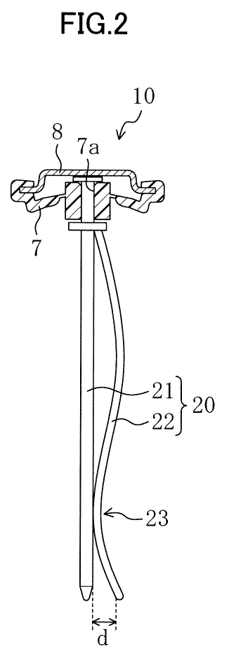

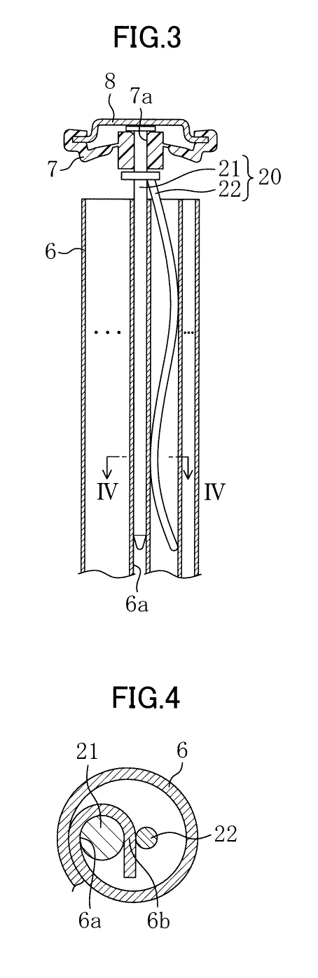

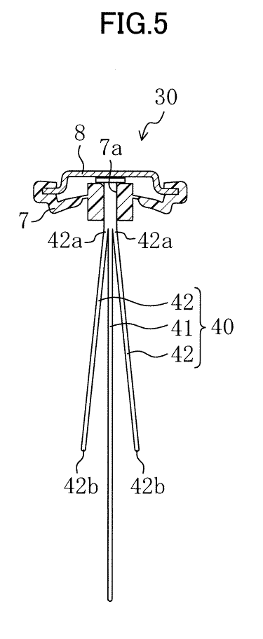

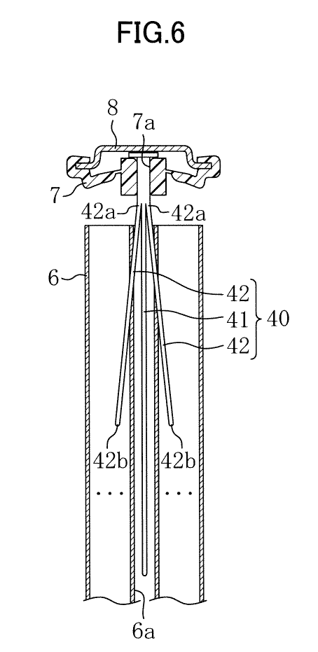

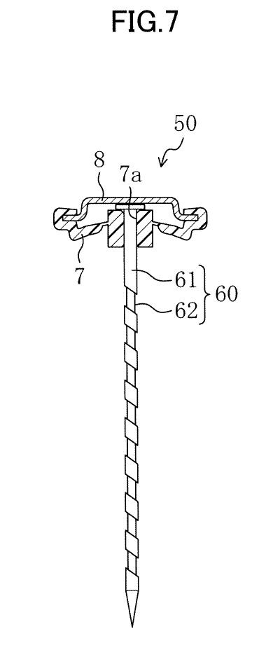

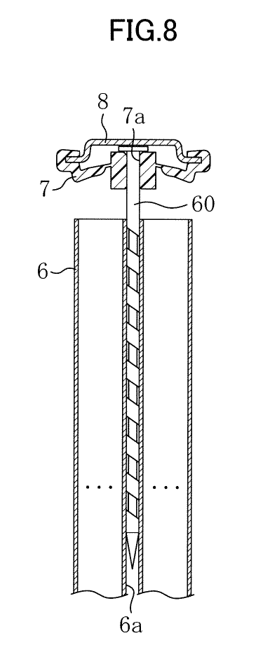

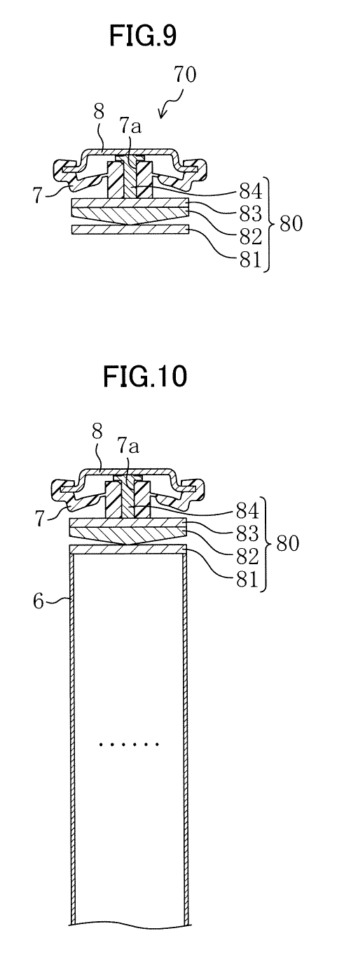

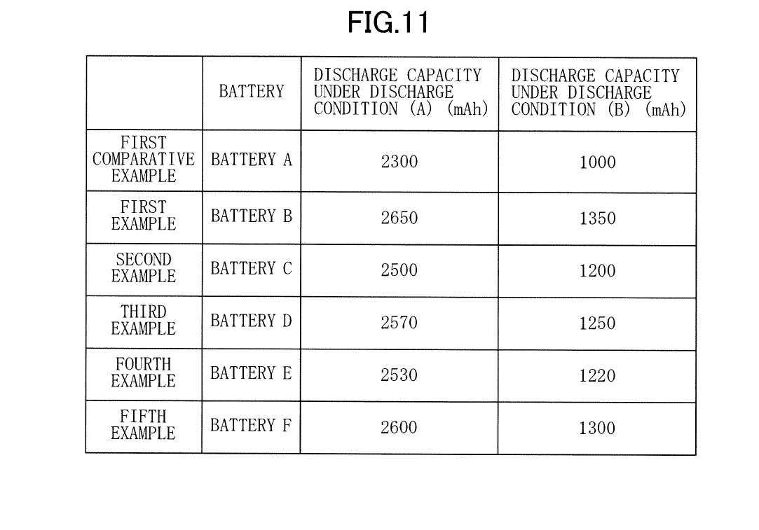

### BRIEF DESCRIPTION OF THE DRAWINGS

[FIG. 1] FIG. 1 is a half-sectional view schematically illustrating an alkaline battery of a first embodiment of the present invention.

[FIG. 2] FIG. 2 is a longitudinal section illustrating an assembled sealing body of the first embodiment of the present invention.

[FIG. 3] FIG. 3 is a longitudinal section illustrating a current collecting structure at a negative electrode of the first embodiment of the present invention.

[FIG. 4] FIG. 4 is a sectional view along the line IV-IV of FIG. 3.

[FIG. 5] FIG. 5 is a longitudinal section illustrating an assembled sealing body of a second embodiment of the present invention.

[FIG. 6] FIG. 6 is a longitudinal section illustrating a current collecting structure at a negative electrode of the second embodiment of the present invention.

[FIG. 7] FIG. 7 is a longitudinal section illustrating an assembled sealing body of a third embodiment of the present invention.

[FIG. 8] FIG. 8 is a longitudinal section illustrating a current collecting structure at a negative electrode of the third embodiment of the present invention.

[FIG. 9] FIG. 9 is a longitudinal section illustrating an assembled sealing body of a fourth embodiment of the present invention.

[FIG. 10] FIG. 10 is a longitudinal section illustrating a current collecting structure at a negative electrode of the fourth embodiment of the present invention.

[FIG. 11] FIG. 11 is a table indicating results of evaluation of the first to fifth examples and a comparative example.

### DESCRIPTION OF EMBODIMENTS

Embodiments of the present invention will be described in detail below with reference to the drawings. The present invention is not limited to the following embodiments. Unless otherwise specified, “upper” and “lower” used in the following embodiments respectively refer to “upper” and “lower” orientation/position relative to an alkaline battery disposed with its negative electrode terminal plate facing upward.

### First Embodiment of the Invention

FIG. 1 is a half-sectional view schematically illustrating an alkaline battery of a first embodiment. In FIG. 1, the detail of a negative electrode current collector 20 is omitted.

The alkaline battery of the present embodiment includes a battery case 1 having a closed bottom. The battery case 1 is made of a nickel-plated steel sheet. A label 11 is provided on an outer circumferential surface of the battery case 1. A positive electrode 3, a separator 4, and a negative electrode 6 are provided in the battery case 1. The positive electrode 3 is in close contact with an inner circumferential surface of the battery case 1 via a film 2 made of graphite, and contains electrolytic manganese dioxide powder (an active material), graphite powder (a conductive agent), and an alkaline electrolyte. The separator 4 is provided inside the positive electrode 3 in the battery case 1. The separator 4 is nonwoven fabric obtained by mixing polyvinyl alcohol fibers and rayon fibers as main components, and retains the alkaline electrolyte. The negative electrode 6 is provided inside the separator 4 in the battery case 1, and is provided on a bottom surface of the battery case 1 via an insulating cap 5. Moreover, the negative electrode 6 is, as described later, a porous sheet made of zinc or a zinc alloy (hereinafter simply referred to as “porous sheet”) wound into spiral.

An assembled sealing body 10 obtained by integrating a sealing plate 7, a negative electrode terminal plate 8, an insulating washer 9, and the negative electrode current collector 20 is provided at an opening of the battery case 1. The opening of the battery case 1 is sealed with the negative electrode terminal plate 8. An upper surface of the negative electrode current collector 20 is in contact with an inner surface of the negative electrode terminal plate 8. The negative electrode current collector 20 is inserted through a through hole 7a of the sealing plate 7 into the negative electrode 6. At a rim of the opening of the battery case 1, the negative electrode terminal plate 8 is crimped via the sealing plate 7. The insulating washer 9 serves as a bridge between a rim of the sealing plate 7 and a center portion of the sealing plate 7 at which the through hole 7a is formed.

Such an alkaline battery can be produced according to the following method. First, a film 2 made of graphite is applied to part of an inner circumferential surface of a battery case 1 having a closed bottom. Then, a plurality of positive electrode mixture pellets containing, for example, a positive electrode active material are provided in the battery case 1, and are pressed. In this way, a positive electrode 3 is formed. Next, a separator 4 and an insulating cap 5 are provided inside the positive electrode 3 in the battery case 1. Thereafter, an alkaline electrolyte is injected in the battery case 1. After that, a negative electrode 6 is provided inside the separator 4 in the battery case 1. Note that the alkaline electrolyte may be injected in the battery case 1 after the negative electrode 6 is provided in the battery case 1. Then, an opening of the battery case 1 is sealed with an assembled sealing body 10, and a label 11 is provided on an outer circumferential surface of the battery case 1.

The negative electrode 6, the negative electrode current collector 20, and a current collecting structure at the negative electrode 6 of the present embodiment will be described below. First, the negative electrode 6 of the present embodiment will be described in comparison with a negative electrode of a commercially available conventional alkaline battery.

The negative electrode of the commercially available conventional alkaline battery includes small lumps of zinc. “Small lumps of zinc” referred to here are not particularly specified in terms of their shape, and are small lumps or small pieces of zinc having a maximum diameter or a maximum length of several micrometers to about 10 mm. “Zinc” referred to here includes a zinc alloy containing a small amount of metal (except for mercury) other than zinc.

Such small lumps of zinc are powder obtained by gas atomization, have an irregular shape like a potato, and are classified with a sieve to have an average particle size of about 180 μm. Examples of such small lumps of zinc include zinc powder (lot No: 70SA-H, containing 50 ppm of Al, 50 ppm of Bi, 200 ppm of In relative to the weight of zinc) manufactured by Mitsui Mining & Smelting Co., Ltd.

By contrast, the negative electrode 6 of the present embodiment is formed by winding a porous sheet into spiral. The porous sheet has a plurality of spaces (not shown), and an alkaline electrolyte is retained in the spaces. The alkaline electrolyte may contain an anionic surfactant and a quaternary ammonium salt-based cationic surfactant, and an indium compound may be added as needed. In the porous sheet except for the spaces, particles of zinc or a zinc alloy are in contact with each other, and thus the conductive network of the negative electrode 6 of the present embodiment is stronger than that of the negative electrode of the commercially available conventional alkaline battery. Note that when metal (In, Bi, Sn, Ge, Cu, or the like) having a higher hydrogen-overvoltage than zinc is contained in the zinc alloy, it is possible to obtain the advantage of reducing the occurrence of hydrogen gas in the alkaline battery.

The porous sheet may be produced according to the method of compressing fibers, or the like made of zinc or a zinc alloy by press molding, or may be produced according to the method of forming a sheet made of zinc or a zinc alloy, and then forming a plurality of pores in the sheet. When the former method is used to produce a porous sheet, the size of fibers made of zinc or a zinc alloy is not particularly limited. However, when fibers each having a diameter of 50 μm or larger, and a length of 10 mm or longer are used to produce a porous sheet, the mechanical strength of the porous sheet can be improved, so that it is possible to keep the shape of the negative electrode 6 in the battery case 1. When fibers each having a diameter of 500 μm or smaller, and a length of 300 mm or shorter are used to produce a porous sheet, it is possible to ensure the surface area of the negative electrode 6 necessary for an electrode reaction. Thus, fibers made of zinc or a zinc alloy each preferably have a diameter of 50 μm to 500 μm, both inclusive, and a length of 10 mm to 300 mm, both inclusive.

Such fibers may be formed by melt spinning. Melt spinning is a generic name for methods of injecting a melt of metal from a nozzle to form an extra fine thread made of the metal. For example, an extra fine thread made of metal can be obtained according to the following method. First, zinc or a zinc alloy is put in a crucible, and is melted by a heater such as a high-frequency coil. Next, argon gas or the like is supplied to a surface of the melted metal (the melted zinc or the melted zinc alloy). Here, due to the pressure of the gas, the melted metal is injected into air through a nozzle, thereby obtaining an extra fine thread made of the metal. Here, the melted metal may be injected in water, and the extra fine thread may rapidly be cooled. Alternatively, cutting, drawing, or the like can be used other than the melt spinning.

Here, the “fibers made of zinc or a zinc alloy” is an example of a material having an elongated shape. Thus, as a zinc material for the porous sheet, any material having an elongated shape and made of zinc or a zinc alloy can be used. The zinc material for the porous sheet is not limited to fibers made of zinc or a zinc alloy.

When materials for the porous sheet have an approximately spherical shape, areas of the materials where the materials are in contact with each other increase, thereby increasing the contact resistance. By contrast, when materials for the porous sheet have an elongated shape, electrons can be transferred in the materials along the longitudinal direction of the materials, so that the areas of the materials where the materials are in contact with each other can be reduced. Thus, it is possible to reduce the increase in contact resistance.

The porous sheet is wound, so that the negative electrode 6 of the present embodiment can be formed. Examples of a method for forming the negative electrode 6 include the method of rolling an end in the longitudinal direction of the porous sheet, and winding the porous sheet with the rolled end being sandwiched between two metal rods. When this method is used to form the negative electrode 6, the end sandwiched between the two metal rods may be “deformed” (for example, the end sandwiched between the two metal rods can slightly be bent), and a hollow part 6a can be faulted in the negative electrode 6. The negative electrode current collector 20 (specifically, a main body 21 of the negative electrode current collector 20) is disposed in the hollow part 6a. Now, the negative electrode current collector 20 will be described.

FIG. 2 is a longitudinal section illustrating the assembled sealing body 10 of the present embodiment. FIG. 3 is a longitudinal section illustrating a current collecting structure at the negative electrode 6 of the present embodiment. FIG. 4 is a sectional view taken along the line IV-IV of FIG. 3. Here, in FIGS. 2 and 3, the exterior of the negative electrode current collector 20 is illustrated, and the insulating washer 9 is omitted.

As illustrated in FIG. 2, the negative electrode current collector 20 of the present embodiment includes the main body 21 in the shape of a rod, and a retainer 22 having a pressure contact part 23. The negative electrode current collector 20 preferably has a width of 1-4 mm. As the main body 21, a tin-plated brass rod (having a diameter of, for example, 1.425 mm, and a length of, for example, 3 cm) may be used. Other than brass, metal such as zinc, copper, tin, silver, nickel, titanium, or magnesium, or an alloy of these metals may be used. Note that when a material for the main body 21 is tin, tin plating is not required. The main body 21 is preferably formed to have a nail shape. A lower end of the nail-shaped main body 21 preferably has an acute shape.

The retainer 22 is preferably made of the same material as that of the main body 21. The retainer 22 is arranged to face part of an outer circumferential surface of the main body 21, and extends in the axial direction of the main body 21. An upper end of the retainer 22 is connected to the main body 21. The pressure contact part 23 of the retainer 22 is pressure contacted to the main body 21. Other portions of the retainer 22 are not in contact with the main body 21. A lower end of the retainer 22 is spaced apart from the main body 21 by a distance of about the thickness of the porous sheet (d the thickness of the porous sheet). A portion of the retainer 22 between the upper end and the pressure contact part 23 is curved to be spaced apart from the main body 21.

The negative electrode current collector 20 can be formed by, for example, spot welding the upper end of the retainer 22 to the main body 21, by fixing the upper end of the retainer 22 to the main body 21 by using a fastening element, or by monolithically molding the main body 21 and the retainer 22. The retainer 22 can be formed by the method of performing a plasticity process on a plate (having a thickness of 0.5-1 mm, a width of 1.5-3 mm, and a length of 3-5 cm).

Note that when the width of the negative electrode current collector 20 is larger than the size of the through hole 7a of the sealing plate 7, the negative electrode current collector 20 may be formed according to any one of the following methods. The main body 21 of the negative electrode current collector 20 is inserted into the through hole 7a of the sealing plate 7, and then the upper end of the retainer 22 is spot welded to the main body 21, or the upper end of the retainer 22 is fixed to the main body 21 by using a fastening element. Alternatively, a rod-like member is inserted into the through hole 7a of the sealing plate 7, and then the rod-like member is processed to monolithically form the main body 21 and the retainer 22.

In the current collecting structure at the negative electrode 6 of the present embodiment, as illustrated in FIG. 3, a connection portion between the main body 21 and the retainer 22 is disposed outside the negative electrode 6, and is closer to the negative electrode 6 than the sealing plate 7 is. The main body 21 is disposed in the hollow part 6a of the negative electrode 6 such that the axial direction of the main body 21 is parallel to the longitudinal direction of the hollow part 6a. The retainer 22 is disposed between portions of the negative electrode 6 which are adjacent to each other in the radial direction of the negative electrode 6. As described above, in the current collecting structure at the negative electrode 6 of the present embodiment, the main body 21 and the retainer 22 sandwich a portion of the negative electrode 6 which is present between the main body 21 and the retainer 22. Thus, even when the negative electrode 6 is deformed due to discharge, specifically, even when a rim in the radial direction of the negative electrode 6 expands, and thus stress is caused inside the negative electrode 6, contact between the negative electrode 6 and the negative electrode current collector 20 can be maintained.

At the pressure contact part 23, the main body 21 and the retainer 22 hold a portion of the negative electrode 6 which is present between the main body 21 and the retainer 22. Thus, even when the negative electrode 6 is deformed due to discharge, it can further be ensured that contact between the negative electrode 6 and the negative electrode current collector 20 is maintained.

Here, the position of the retainer 22 in the negative electrode 6 is not particularly limited. However, when the retainer 22 is arranged close to the rim in the radial direction of the negative electrode 6, the number of porous sheets sandwiched between the main body 21 and the retainer 22 is large, and thus the retainer 22 is severely strained. This may break the retainer 22, or the negative electrode current collector 20, so that the negative electrode 6 may not be brought into contact with the negative electrode current collector 20. When the retainer 22 is severely strained, the porous sheet may be bent or ruptured when the negative electrode 6 is sandwiched, which leads to degradation of the production yield of the alkaline battery.

By contrast, when the retainer 22 is arranged close to the center in the radial direction of the negative electrode 6, the number of porous sheets sandwiched between the main body 21 and the retainer 22 can be small, and thus it is possible to reduce the strain imposed on the retainer 22. In this way, the retainer 22 or the negative electrode current collector 20 can be prevented from being broken, and thus the negative electrode 6 can be brought into contact with the negative electrode current collector 20. Moreover, the negative electrode 6 can be sandwiched without the porous sheet being bent or ruptured, so that it is possible to reduce the degradation of the production yield of the alkaline battery. Therefore, it is preferable to arrange the retainer 22 close to the center in the radial direction of the negative electrode 6.

More preferably, the retainer 22 is arranged between an innermost circumference portion of the negative electrode 6 and a next innermost circumference portion in the radial direction of the negative electrode 6. In this case, the number of porous sheets sandwiched between the main body 21 and the retainer 22 can be one, and thus it is possible to reduce the strain imposed on the retainer 22. Therefore, it is possible to bring the negative electrode 6 into connection with the negative electrode current collector 20, and to prevent the degradation of the production yield of the alkaline battery.

Most preferably, as illustrated in FIG. 4, the “deformed” part 6b of the innermost circumference portion of the negative electrode 6 is sandwiched between the main body 21 and the retainer 22. In this case, in addition to the above advantage, it is also possible to obtain the advantage that the main body 21 and the retainer 22 can easily sandwich a portion of the negative electrode 6 which is present between the main body 21 and the retainer 22.

As a method for forming the current collecting structure at the negative electrode 6, in other words, as a method for disposing the negative electrode current collector 20 in the negative electrode 6, for example, the following method can be used. First, the negative electrode 6 is formed according to the above method, and the assembled sealing body 10 including the negative electrode current collector 20 is prepared. Next, above an upper surface of the negative electrode 6, the assembled sealing body 10 is arranged with the negative electrode terminal plate 8 facing upward. Subsequently, the lower end of the main body 21 of the negative electrode current collector 20 is inserted in the hollow part 6a of the negative electrode 6, and the lower end of the retainer 22 is inserted between portions of the negative electrode 6 which are adjacent to each other in the radial direction of the negative electrode. Then, the negative electrode current collector 20 is moved into the negative electrode 6. When the upper surface of the negative electrode 6 is brought into contact with the pressure contact part 23, the retainer 22 moves away from the main body 21, so that a portion of the negative electrode 6 which is present between the main body 21 and the retainer 22 is held by the main body 21 and the retainer 22. Thereafter, the negative electrode current collector 20 is further moved into the negative electrode 6. Before the connection portion between the main body 21 and the retainer 22 is inserted into the negative electrode 6, the negative electrode current collector 20 is stopped.

Here, at a lower end of the negative electrode current collector 20, that is, a tip in the insertion direction of the negative electrode current collector 20, the main body 21 is separated apart from the retainer 22 by a distance of about the thickness of the porous sheet. Thus, the negative electrode current collector 20 can be inserted into the negative electrode 6, while the negative electrode 6 is not bent or ruptured, the retainer 22 is not ruptured, and the negative electrode current collector 20 is not broken. In this way, it is possible to reduce degradation of the production yield of the alkaline battery.

As described above, in the current collecting structure at the negative electrode 6 of the present embodiment, the main body 21 and the retainer 22 sandwich a portion of the negative electrode 6 which is present between the main body 21 and the retainer 22. Moreover, in the current collecting structure at the negative electrode 6, the main body 21 and the retainer 22 hold, at the pressure contact part 23, a portion of the negative electrode 6 which is present between the main body 21 and the retainer 22. Thus, even when the negative electrode 6 is deformed due to discharge, contact between the negative electrode 6 and the negative electrode current collector 20 can be ensured, so that it is possible to reduce degradation of the current collection performance at the negative electrode 6. In particular, even at the end stage of discharge in which the negative electrode 6 is significantly deformed due to discharge, degradation in current collection performance at the negative electrode 6 can be reduced, so that it is possible to reduce the degradation in discharge characteristics.

Moreover, the negative electrode 6 of the present embodiment is formed by winding a porous sheet, and thus the contact resistance between the negative electrode active materials can be reduced compared to the negative electrode using gelled zinc. Thus, it is possible to establish strong conductive network at the negative electrode compared to the conventional case, which can also reduce degradation in discharge characteristic.

Furthermore, in the present embodiment, the main body 21 of the negative electrode current collector 20 is inserted into the through hole 7a of the sealing plate 7. Thus, it is not necessary to weld the sealing plate 7 to the negative electrode current collector 20. Therefore, sputtered substances may not enter the positive electrode 3 or the negative electrode 6, and thus gas generation due to contamination by the sputtered substances may not occur, so that it is possible to prevent leakage of the alkaline electrolyte. Thus, the present embodiment can provide a highly safe alkaline battery.

Note that the negative electrode current collector 20 of the present embodiment may have the following configuration.

The main body and the retainer may be made of conductive materials which are different from each other.

Multiple ones of the retainer may be provided. In order to obtain the effect of maintaining contact between the negative electrode and the negative electrode current collector, the number of retainers is preferably large. However, when the number of the retainers is too large, production of the negative electrode current collector may become complicated, and production of the current collecting structure of the negative electrode may take long time. Thus, the number of the retainers is preferably determined in consideration of the foregoing. This also applies to the pressure contact part.

Moreover, the negative electrode 6 of the present embodiment is formed by winding a porous sheet, and thus the alkaline battery of the present embodiment may be designed as described in the following variation.

-Variations-

In an alkaline battery of the present variation, 1.0≦(x/y)≦1.5, where the total mass of an alkaline electrolyte in a battery case 1 is x [g], and the mass of zinc in the negative electrode 6 is y [g]. Here, the total mass of the alkaline electrolyte in the battery case 1 includes the mass of the alkaline electrolyte in a positive electrode 3, a separator 4, and a negative electrode 6.

In general, in a commercially available conventional alkaline battery generally, (x/y)<1.0. The reason for this is that a negative electrode active material of the commercially available conventional alkaline battery is zinc powder, and thus a problem such as a reduction in strength of conductive network of a negative electrode, sedimentation of the zinc powder in the negative electrode, or the like arises when 1.0≦(x/y).

However, the negative electrode 6 of the alkaline battery of the present variation is formed by winding a porous sheet, and thus the problem does not arise even when 1.0≦(x/y). When 1.0≦(x/y), a necessary amount of the alkaline electrolyte for a discharge reaction can be filled in the battery case 1, and thus the utilization of the negative electrode can be increased compared to that of the commercially available conventional alkaline battery. When (x/y)≦1.5, the amount of the negative electrode active material filled in the battery case 1 can be increased compared to the commercially available conventional alkaline battery. Thus, the capacity of the alkaline battery can be increased.

Moreover, in the alkaline battery of the present variation, 0.9≦(capacity of the negative electrode/capacity of the positive electrode)≦1.1, where the capacity of a positive electrode is calculated on the condition that a positive electrode active material (manganese dioxide) has a theoretical capacity of 308 mAh/g, and the capacity of the negative electrode is calculated on the condition that the negative electrode active material (zinc) has a theoretical capacity of 820 mAh/g.

In general, in the commercially available conventional alkaline battery, (capacity of the negative electrode/capacity of the positive electrode)>1.1. The reason for this is that the utilization of a gelled negative electrode is significantly lower than that of the positive electrode, and thus the negative electrode has to be contained in the battery case in an amount excessively greater than the theoretical value.

However, in the alkaline battery of the present variation, the negative electrode 6 is formed by winding a porous sheet, and thus the utilization of the negative electrode 6 is higher than that of the gelled negative electrode. Thus, it is possible that (capacity of the negative electrode/capacity of the positive electrode)≦1.1, so that the amount of the positive electrode active material filled in the battery case 1 can be increased compared to the commercially available conventional alkaline battery. Therefore, the capacity of the alkaline battery can be increased. Moreover, when (capacity of the negative electrode/capacity of the positive electrode)≧0.9, the amount of the negative electrode active material filled in battery case 1 can be increased compared to the commercially available conventional alkaline battery. This can also increase the capacity of the alkaline battery.

As described above, in addition to the advantages obtained in the first embodiment, the present variation further provides the advantages of increasing the utilization of the negative electrode and increasing the capacity of the alkaline battery compared to the commercially available conventional alkaline battery.

Note that the present variation is applicable to second to fourth embodiments described below.

### Second Embodiment of the Invention

An alkaline battery of a second embodiment includes a negative electrode current collector which is different from that of the first embodiment. The negative electrode current collector of the present embodiment will be described below.

FIG. 5 is a longitudinal section illustrating an assembled sealing body 30 of the present embodiment. FIG. 6 is a longitudinal section illustrating a current collecting structure at a negative electrode 6 of the present embodiment. Here, in FIGS. 5 and 6, the exterior of a negative electrode current collector 40 is illustrated, and an insulating washer 9 is omitted.

The negative electrode current collector 40 of the present embodiment includes a main body 41 in the shape of a rod and two inclined members 42. The main body 41 is preferably made of any one of the materials listed for the main body 21 in the first embodiment.

Each inclined member 42 is preferably, for example, a rod-like member having a diameter of 1-1.5 mm and a length of 2-3 cm, and is inclined relative to the axial direction of the main body 41. Each inclined member 42 has an upper end 42a connected to the main body 41, and a lower end 42b spaced apart from the main body 41.

The negative electrode current collector 40 may be formed by welding the upper ends 42a of the inclined members 42 to the main body 41 by, for example, spot welding, or by monolithically molding the main body 41 and the inclined members 42.

Note that when the width of the negative electrode current collector 40 is larger than the size of a through hole 7a of a sealing plate 7, the negative electrode current collector 40 may be formed according to either of the following methods. The main body 41 of the negative electrode current collector 40 is inserted into the through hole 7a of the sealing plate 7, and then the upper ends of the inclined members 42 are spot welded to the main body 41. Alternatively, a rod-like member is inserted into the through hole 7a of the sealing plate 7, and then the rod-like member is processed to monolithically form the main body 41 and the inclined members 42.

In the current collecting structure at the negative electrode 6 of the present embodiment, the main body 41 is disposed in a hollow part 6a of the negative electrode 6 such that the axial direction of the main body 41 is parallel to the longitudinal direction of the hollow part 6a. Since each inclined member 42 extends from its portion connected to the main body 41 (the upper end 42a of the inclined member 42) in a direction inclined relative to the axial direction of the main body 41, the inclined member 42 is inserted from the hollow part 6a into the negative electrode 6. Thus, the lower end 42b of each inclined member 42 is disposed in the negative electrode 6. With this configuration, even when stress is caused inside the negative electrode 6, contact between the negative electrode 6 and the negative electrode current collector 40 can be maintained.

As a method for forming the current collecting structure at the negative electrode 6, in other words, as a method for inserting the negative electrode current collector 40 into the negative electrode 6, the following method can be used. First, the negative electrode 6 is formed according to the method described in the first embodiment. Next, the assembled sealing body 30 including the negative electrode current collector 40 of the present embodiment inserted into the through hole 7a of the sealing plate 7 is prepared. Subsequently, the assembled sealing body 30 is arranged above an upper surface of the negative electrode 6 with its negative electrode terminal plate 8 facing upward. Then, the negative electrode current collector 40 is moved into the hollow part 6a of the negative electrode 6. Thus, the main body 41 of the negative electrode current collector 40 is placed in the hollow part 6a of the negative electrode 6, and the lower ends 42b of the inclined members 42 are inserted into the negative electrode 6 because the inclined members 42 extend in a direction inclined relative to the axial direction of the main body 41.

As described above, in the current collecting structure at the negative electrode 6 of the present embodiment, the lower ends 42b of the inclined members 42 of the negative electrode current collector 40 are disposed in the negative electrode 6. Thus, even when the negative electrode 6 is deformed due to discharge, connection between the negative electrode 6 and the negative electrode current collector 40 can be maintained. Thus, the present embodiment can also provide the advantages described in the first embodiment.

Note that the negative electrode current collector 40 of the present embodiment may have the following configuration.

The number of the inclined members is not limited to two. Even with one inclined member, as long as the lower end of the inclined member is disposed in the negative electrode, connection between the negative electrode and the negative electrode current collector can be maintained even when the negative electrode is deformed due to discharge. However, for only one inclined member, if the inclined member is broken or falls out of the negative electrode, it becomes difficult to bring the negative electrode in contact with the negative electrode current collector. Thus, a plurality of inclined members are preferably provided. In this case, the inclined members are preferably disposed in a radial pattern as illustrated in FIG. 5 or FIG. 6.

However, the increased number of inclined members causes a problem such as longer time taken to produce the negative electrode current collector due to complicated production of the negative electrode current collector, or deterioration of the production yield of the negative electrode current collector. When the number of the inclined members increases, the ratio of the total volume of the negative electrode current collector relative to the volume of a hollow of the separator (the volume inside the separator of the battery case) increases, which reduces the volume of the negative electrode in the hollow of the separator. Therefore, the content of zinc is reduced, and thus the capacity of the alkaline battery also decreases. In view of the foregoing, the number of inclined members is preferably two or more and seven or less.

The inclination of each inclined member relative to the main body is not particularly limited. It is sufficient that the lower end of each inclined member is disposed in the negative electrode. Therefore, it is preferable that the inclination of the inclined member be accordingly set depending on the diameter of the main body or the length of the inclined member, or depending on methods or conditions for forming the negative electrode current collector.

### Third Embodiment of the Invention

An alkaline battery of a third embodiment includes a negative electrode current collector which is different from those of the first and second embodiments. The negative electrode current collector of the present embodiment will mainly be described below.

FIG. 7 is a longitudinal section illustrating an assembled sealing body 50 of the present embodiment. FIG. 8 is a longitudinal section of a current collecting structure at a negative electrode 6 of the present embodiment. Here, in FIGS. 7 and 8, the exterior of a negative electrode current collector 60 is illustrated, and an insulating washer 9 is omitted.

The negative electrode current collector 60 of the present embodiment includes a main body 61 in the shape of a rod, wherein a raised/recessed part 62 is formed on a side surface of the main body 61. The negative electrode current collector 60 is formed by, for example, performing a turning process on the side surface of the main body 61 (having a diameter of 3-6 mm, and a length of 3-4 cm) made of brass. The raised/recessed part 62 may be formed in a helical pattern relative to the axial direction of the main body 61 as illustrated in FIG. 7, in a parallel pattern relative to the axial direction of the main body 61, or in a perpendicular pattern relative to the axial direction of the main body 61. With this configuration, the surface area of the side surface of the main body 61 can be increased compared to the case where the raised/recessed part 62 is not formed on the side surface of the main body 61. Now, the current collecting structure at the negative electrode 6 of the present embodiment will be described.

In the current collecting structure at the negative electrode 6 of the present embodiment, the main body 61 is disposed in a hollow part 6a of the negative electrode 6 such that the axial direction of the main body 61 is parallel to the longitudinal direction of the hollow part 6a. The raised/recessed part 62 is formed on the side surface of the main body 61. A portion of the side surface of the negative electrode current collector 60 which is positioned close to the negative electrode 6 in the radial direction of the main body 61 is in contact with the negative electrode 6. As described above, when the raised/recessed part 62 is formed on the side surface of the main body 61, the surface area of the side surface of the main body 61 can be increased. Thus, the contact area between the negative electrode 6 and the negative electrode current collector 60 can be increased. Therefore, even when the negative electrode 6 is deformed due to discharge, contact between the negative electrode 6 and the negative electrode current collector 60 can be maintained compared to the case where the raised/recessed part is not formed on the side surface of the main body of the negative electrode current collector.

As a method for forming the current collecting structure at the negative electrode 6, in other words, as a method for disposing the negative electrode current collector 60 in the negative electrode 6, the following method can be used. First, the negative electrode 6 is formed according to the method described in the first embodiment. Next, the assembled sealing body 50 including the negative electrode current collector 60 of the present embodiment inserted into a through hole 7a of a sealing plate 7 is prepared. Subsequently, the assembled sealing body 50 is arranged above an upper surface of the negative electrode 6 with its negative electrode terminal plate 8 facing upward. Then, the negative electrode current collector 60 is moved into hollow part 6a of the negative electrode 6 so that a portion of the side surface of the negative electrode current collector 60 which is located close to the negative electrode 6 in the radial direction of the main body 61 is brought into contact with the negative electrode 6.

Here, when the raised/recessed part 62 of the negative electrode current collector 60 is formed in a helical pattern relative to the axial direction of the main body 61, the negative electrode current collector 60 can be inserted into the hollow part 6a while being turned in the circumferential direction of the main body 61 even when the internal diameter of the hollow part 6a of the negative electrode 6 is smaller than the outer diameter of the main body 61. When the internal diameter of the hollow part 6a of the negative electrode 6 is smaller than the outer diameter of the main body 61, the number of positions at which the negative electrode 6 and the negative electrode current collector 60 are in contact with each other can be increased compared to the case where the internal diameter of the hollow part 6a of the negative electrode 6 is larger than or equal to the outer diameter of the main body 61. Therefore, the case where the raised/recessed part 62 of the negative electrode current collector 60 is formed in a helical pattern relative to the axial direction of the main body 61 is preferable compared to the case where the raised/recessed part 62 of the negative electrode current collector 60 is not formed in a helical pattern relative to the axial direction of the main body 61 (for example, the raised/recessed part 62 is formed in a parallel pattern or a perpendicular pattern relative to the axial direction of the main body 61).

As described above, the current collecting structure at the negative electrode 6 of the present embodiment can increase the contact area between the negative electrode 6 and the negative electrode current collector 60. Thus, even when the negative electrode 6 is deformed due to discharge, contact between the negative electrode 6 and the negative electrode current collector 60 can be maintained. Therefore, the present embodiment can also provide the advantages described in the first embodiment.

Moreover, the negative electrode current collector 60 of the present embodiment is the main body 61 in the shape of a rod having the raised/recessed part 62. Thus, the negative electrode current collector 60 can easily be formed compared to those of the first and second embodiments. Moreover, the negative electrode current collector 60 can easily be inserted into the hollow part 6a of the negative electrode 6 compared to those of the first and second embodiment.

Furthermore, when the raised/recessed part 62 of the negative electrode current collector 60 of the present embodiment is formed in a helical pattern relative to the axial direction of the main body 61, the negative electrode current collector 60 can be inserted into the hollow part 6a of the negative electrode 6 while turning the negative electrode current collector 60 in the circumferential direction of the main body 61. Thus, it is possible to further obtain the advantage that the negative electrode current collector 60 can relatively easily be inserted into the hollow part 6a of the negative electrode 6.

Note that the negative electrode current collector 60 of the present embodiment may have the following configuration.

The raised/recessed part may be a recessed part which is recessed from the side surface of the main body, a raised part which protrudes from the side surface of the main body, or a raised/recessed part including recesses and protrusions on the side surface of the main body.

The pitch of the raised/recessed part is not particularly limited. The smaller the pitch of the raised/recessed part is, the larger the contact area between the negative electrode and the negative electrode current collector is. However, when the pitch of the raised/recessed part is too small, production of the negative electrode current collector becomes complicated. The pitch of the raised/recessed part can be determined in view of the foregoing. For a similar reason, the depth of the raised/recessed part is not particularly limited.

### Fourth Embodiment of the Invention

An alkaline battery of a fourth embodiment includes a negative electrode current collector which is different from those of the first to third embodiments. The negative electrode current collector of the present embodiment will mainly be described below.

FIG. 9 is a longitudinal section illustrating an assembled sealing body 70 of the present embodiment. FIG. 10 is a longitudinal section illustrating a current collecting structure at a negative electrode 6 of the present embodiment. Here, in FIGS. 9 and 10, an insulating washer 9, and a hollow part 6a of the negative electrode 6 are omitted.

The present embodiment includes a negative electrode current collector 80 without the main body 21, 41, or 61 respectively of the first, second, or third embodiment. Instead, the negative electrode current collector 80 includes a first cover plate (cover plate) 81, a spring body 82, a second cover plate 83, and a current collector rod 84. The spring body 82 is sandwiched between the first cover plate 81 and the second cover plate 83. The current collector rod 84 is disposed on the second cover plate 83.

The first cover plate 81 and the second cover plate 83 are each, for example, a tin-plated brass circular plate (having a diameter of 5-8 mm, and a thickness of 1 mm). The spring body 82 is, for example, a brass circular plate (having an outer diameter of 5-8 mm, and hollow diameter of 2-6 mm). The spring body 82 is preferably a disc spring with an outer diameter that decreases toward the first cover plate 81. The current collector rod 84 is preferably made of any one of the materials listed for the main body 21 in the first embodiment, and is disposed in a through hole 7a of a sealing plate 7. A lower surface of the current collector rod 84 is flush with a lower surface of the sealing plate 7, and is in contact with an upper surface of the second cover plate 83. Now, the current collecting structure at the negative electrode 6 of the present embodiment will be described.

In the current collecting structure at the negative electrode 6 of the present embodiment, the negative electrode current collector 80 is arranged such that the first cover plate 81 covers an upper surface of the negative electrode 6. The first cover plate 81, the spring body 82, the second cover plate 83, and the sealing plate 7 including the current collector rod 84 in the through hole 7a are provided in this order on the upper surface of the negative electrode 6. With this configuration, the gravitational force of the second cover plate 83 and the weight of the current collector rod 84 disposed in the through hole 7a of the sealing plate 7 are transferred to the first cover plate 81 via the spring body 82. Thus, the second cover plate 83 and the current collector rod 84 serve as a pressure member pressing the first cover plate 81 against the upper surface of the negative electrode 6. Therefore, in the current collecting structure at the negative electrode 6 of the present embodiment, even when the negative electrode 6 is deformed due to discharge, contact between the negative electrode 6 and the negative electrode current collector 80 can be maintained.

Moreover, the spring body 82 has an outer diameter that decreases toward the first cover plate 81. Thus, the first cover plate 81 can easily be pressed against the upper surface of the negative electrode 6 compared to the case where the spring body has an outer diameter that increases toward the first cover plate 81, or the case where the spring body has a uniform diameter in the direction to the first cover plate 81.

To form the current collecting structure at the negative electrode 6, the following method can be used. First, the negative electrode 6 is formed according to the method described in the first embodiment. Next, the first cover plate 81, the spring body 82, and the second cover plate 83 are arranged in this order on the upper surface of the negative electrode 6. Subsequently, a member obtained by integrating the sealing plate 7 including the current collector rod 84 in the through hole 7a, the negative electrode terminal plate 8, and the insulating washer 9 is arranged on the second cover plate 83. Here, the spring body 82 is preferably arranged on the first cover plate 81 such that the outer diameter of the spring body 82 decreases in the direction toward the first cover plate 81.

As described above, in the current collecting structure at the negative electrode 6 of the present embodiment, the second cover plate 83 and the current collector rod 84 press the first cover plate 81 against the upper surface of the negative electrode 6 via the spring body 82. Thus, even when the negative electrode 6 is deformed due to discharge, contact between the negative electrode 6 and the negative electrode current collector 80 can be maintained. Therefore, the present embodiment can also provide the advantages described in the first embodiment.

Note that the negative electrode current collector 80 of the present embodiment may have the following configuration.

The outer diameter of the spring body may increase toward the first cover plate, or may be uniform in the direction to the first cover plate. In both of the cases, even when the negative electrode is deformed due to discharge, contact between the negative electrode and the negative electrode current collector can be maintained. However, when the outer diameter of the spring plate decreases toward the first cover plate, as described above, the first cover plate 81 can easily be pressed against the upper surface of the negative electrode 6.

Thus, the outer diameter of the spring plate preferably decreases toward the first cover plate. Note that in both of the cases, a maximum value of the outer diameter of the spring body is preferably equal to or smaller than the diameter of the first cover plate.

### Other Embodiments

The negative electrode may have the following configuration.

Portions of the negative electrode which are adjacent to each other in the radial direction of the negative electrode may be connected to each other by zinc or metal having a higher hydrogen-overvoltage than zinc. With this configuration, the current collecting direction at the negative electrode can be the radial direction of the negative electrode, so that it is possible to reduce resistance during current collection. When the portions of the negative electrode which are adjacent to each other in the radial direction of the negative electrode are connected to each other by using metal having a higher hydrogen-overvoltage than zinc, generation of hydrogen gas in the alkaline battery can be reduced, so that it is possible to prevent leakage of the alkaline electrolyte.

A porous sheet may be subjected to etching with acid or alkali before being wound. The surface area of the porous sheet can be increased by the etching, so that it is possible to improve the pulse discharge characteristic of the alkaline battery under high load.

The battery case, the positive electrode active material, the conductive agent for the positive electrode, the separator, and the material for the alkaline electrolyte are not limited to those described above. Moreover, the shapes of the sealing plate, the negative electrode terminal plate, and the insulating washer are not limited to those described above.

### EXAMPLES

Examples of the present invention will be described. In the present examples, AA-size alkaline batteries were produced according to the following method, and the produced AA-size alkaline batteries were discharged in two ways.

1. Production of AA-size Alkaline Battery

### First Example

In a first example, a negative electrode current collector illustrated in FIG. 2 was used to produce an AA-size alkaline battery.

—Method for Forming Negative Electrode Current Collector—

First, a brass rod (having a diameter of 1.425 mm, and a length of 3 cm) was plated with tin, thereby forming a main body of the negative electrode current collector. Here, a lower end of the main body of the negative electrode current collector was pointed at an acute angle.

Next, a plate (having a thickness of 0.5 mm, a width of 2 mm, and a length of 3 cm) made of the same material as that of the main body was subjected to deformation processing so that the plate was laid along a metal mold having a curved shape. In this way, a retainer of the negative electrode current collector was formed.

Then, an upper end of the retainer was spot welded to the main body, thereby forming the negative electrode current collector of the present example. Here, the formed negative electrode current collector had a width of 3.5 mm, and a distance (d) of 2 mm between the main body and the retainer at a lower end of the negative electrode current collector.

Note that since the width of the negative electrode current collector was larger than the size of a through hole of a sealing plate, the main body of the negative electrode current collector was first inserted into the through hole of the sealing plate, and then the retainer was spot welded to the main body in practice.

—Method for Producing AA-size Alkaline Battery—

First, a negative electrode was formed according to the following process.

Zinc powder (lot No.: 70SA-H, containing 50 ppm of Al, 50 ppm of Bi, and 200 ppm of In relative to the weight of zinc) manufactured by Mitsui Mining & Smelting Co., Ltd. was used as a material to produce zinc fibers by melt spinning. Each zinc fiber had a wire diameter (the diameter of a circle including the cross section of the fiber) of 0.1 mm, and a length of 10 cm. Then, 3.83 g of the zinc fibers were formed into a sheet (having a longitudinal length of 4.13 cm, a lateral length of 5.46 cm, and a thickness of 0.1 cm). In this way, a porous sheet was obtained.

Here, to form the porous sheet, a metal mold having a through hole (having a depth of 1 cm, a longitudinal length of 4.13 cm, and a lateral length of 5.46 cm) with an opening in a rectangular shape, and two metal plates for pressing a sample provided in the through hole from the top and the bottom were used.

In a method for forming the porous sheet, the metal mold having the through hole was first horizontally laid, and then a first metal plate (having a thickness of 0.5 cm, a longitudinal length of 4.13 cm, and a lateral direction of 5.46 cm) was arranged in the through hole. In this way, the opening at a lower surface of the metal mold was sealed with the first metal plate. Next, a predetermined amount of the zinc fibers were substantially uniformly put in a space defined by a side surface that is a side surface of the through hole of the metal mold, and by a bottom surface that is an upper surface of the first metal plate. After that, on the zinc fibers put in the space, a second metal plate (having a thickness of 1 cm, a longitudinal length of 4.13 cm, and a lateral length of 5.46 cm) was arranged, and pressure was exerted on the second metal plate until space between the first metal plate and the second metal plate decreased to 1 mm, thereby consolidating the zinc fibers by pressing. In this way, the porous sheet having a thickness of 1 mm was formed. Then, the metal mold including the two metal plates and the porous sheet provided in the through hole was turned upside down, and the upper metal plate (the first metal plate) was removed. Thereafter, light pressure was exerted on the metal mold to take the porous sheet out of the metal mold.

The formed porous sheet was rolled by a width of about 1.5 mm from an end of the porous sheet, and the rolled portion was sandwiched between two metal rods to wind the porous sheet. The negative electrode was thus formed. Here, a portion of the porous sheet which was sandwiched between the two metal rods was “deformed.” Moreover, a hollow part was formed in the negative electrode.

After that, to the negative electrode, 54 parts by weight (pbw) of a 33 weight percent (wt. %) potassium hydroxide aqueous solution (containing 2 wt. % of ZnO) and 0.03 pbw of indium hydroxide (0.0197 pbw of indium metal) relative to 100 pbw of the negative electrode were added and mixed. Note that it is preferable to further add to the negative electrode, 0.7 pbw of cross-linked polyacrylic acid as a dispersion medium, and 1.4 pbw of cross-linked sodium polyacrylate relative to 100 pbw of the negative electrode.

Next, a positive electrode was formed. Specifically, electrolytic manganese dioxide and graphite were mixed in the weight ratio of 94:6. To the mixed powder, 1 pbw of an electrolyte (a 39 wt. % potassium hydroxide aqueous solution containing 2 wt. % of ZnO) relative to 100 pbw of the mixed powder was mixed, and the mixture was uniformly stirred and mixed with a mixer to granulate the mixture into a certain size. The obtained granules were press-molded using a hollow cylindrical mold, thereby producing a positive electrode material mixture pellet. Electrolytic manganese dioxide used was HH-TF manufactured by Tosoh Corporation, and graphite used was SP-20 manufactured by Nippon Graphite Industries, ltd.

Subsequently, the obtained positive electrode mixture pellet was provided in a battery case, and then a separator and an insulating cap were inserted. The separator used was Vinylon lyocell composite nonwoven fabric manufactured by Kuraray Co., Ltd. Then, the negative electrode containing the potassium hydroxide aqueous solution and the indium hydroxide was provided in the battery case, and a 33 wt. % potassium hydroxide aqueous solution (containing 2 wt. % of ZnO) was injected inside the separator.

Then, an assembled sealing body was formed by integrating the negative electrode current collector, the sealing plate, a negative electrode terminal plate, and an insulating washer. After that, the lower end of the main body of the negative electrode current collector was inserted into the hollow part of the negative electrode, and a lower end of the retainer of the negative electrode current collector was inserted into the negative electrode, thereby sandwiching the portion of the negative electrode, which was present between the two metal rods in winding the negative electrode by the main body and the retainer. Before a connection portion between the main body and the retainer was inserted into the hollow part of the negative electrode, the insertion of the negative electrode current collector into the negative electrode was stopped. Thereafter, an opening of the battery case was sealed with the negative electrode terminal plate of the assembled sealing body. In this way, the AA-size alkaline battery of the present example was produced.

### Second Example

In a second example, a negative electrode current collector illustrated in FIG. 5 was used to produce an AA-size alkaline battery.

—Method for Forming Negative Electrode Current Collector—

First, a brass rod (having a diameter of 1.425 mm, and a length of 3 cm) was plated with tin, thereby forming a main body of the negative electrode current collector. Here, a lower end of the main body of the negative electrode current collector was pointed at an acute angle.

Next, upper ends of two rods (each having a diameter of 1 mm, and a length of 2 cm) made of the same material as that of the main body were spot welded to the main body of the negative electrode current collector. In this way, the two inclined members were connected to the main body of the negative electrode current collector, thereby forming the negative electrode current collector of the present example.

Note that since the width of the negative electrode current collector was larger than the size of a through hole of a sealing plate, the main body of the negative electrode current collector was first inserted into the through hole of the sealing plate, and then the inclined members were spot welded to the main body in practice.

—Method for Producing AA-size Alkaline Battery—

According to the method described in the first example, a positive electrode, a negative electrode, and an alkaline electrolyte were provided in a battery case. Then, an assembled sealing body was formed by integrating the negative electrode current collector, the sealing plate, a negative electrode terminal plate, and an insulating washer. After that, the negative electrode current collector was inserted into a hollow part of the negative electrode. In this case, the main body of the negative electrode current collector was placed in the hollow part, but the inclined members of the negative electrode current collector were inserted into the negative electrode from the hollow part. Thereafter, an opening of the battery case was sealed with the negative electrode terminal plate of the assembled sealing body. In this way, the AA-size alkaline battery of the present example was produced.

### Third Example

In a third example, a negative electrode current collector which was the same as the negative electrode current collector of the second example except that seven inclined members were provided was used to produce an AA-size alkaline battery.

—Method for Forming Negative Electrode Current Collector—

First, a brass rod (having a diameter of 1.425 mm, and a length of 3 cm) was plated with tin, thereby forming a main body of the negative electrode current collector.

Next, upper ends of seven rods (each having a diameter of 1 mm, and a length of 2 cm) made of the same material as that of the main body were spot welded to the main body of the negative electrode current collector. In this way, the seven inclined members were connected to the main body of the negative electrode current collector, thereby forming the negative electrode current collector of the present example.

Note that it was impossible to spot welding eight or more rods to the main body of the negative electrode current collector.

—Method for Producing AA-size Alkaline Battery—

The negative electrode current collector of the present example was used to produce the AA-size alkaline battery according to the method described in the second example.

### Fourth Example

In a fourth example, a negative electrode current collector illustrated in FIG. 7 was used to produce an AA-size alkaline battery.

—Method for Forming Negative Electrode Current Collector—

First, on a surface of a brass rod (which is a main body of the negative electrode current collector, and has a diameter of 5 mm, and a length of 3 cm), a recessed portion and a raised portion were formed by a turning process. Here, the recessed portion and the raised portion were formed in a helical pattern relative to the axial direction of the rod. Moreover, the thickness of the rod after the turning process (the thickness from the raised portion at one side to the raised portion at the other side) was substantially the same as that of the rod before the turning process.

Next, the rod with the surface having the recessed portion and the raised portion was plated with tin. In this way, the negative electrode current collector of the present example was formed.

—Method for Producing AA-size Alkaline Battery—

A positive electrode, a negative electrode, and an alkaline electrolyte were provided in a battery case according to the method described in the first example. Then, the negative electrode current collector of the present example was inserted into a through hole of a sealing plate to form an assembled sealing body in which the negative electrode current collector, the sealing plate, a negative electrode terminal plate, and an insulating washer were integrated. After that, the negative electrode current collector was inserted into a hollow part of the negative electrode so that the negative electrode current collector was closely in contact with the negative electrode, and an opening of the battery case was sealed with the negative electrode terminal plate of the assembled sealing body. In this way, the AA-size alkaline battery of the present example was produced.

### Fifth Example

In a fifth example, a negative electrode current collector illustrated in FIG. 9 was used to produce an AA-size alkaline battery.

—A method for Forming Negative Electrode Current Collector—

A disc spring (which is a spring body, and is a hollow circular plate having an outer diameter of 7 mm, and a hollow diameter of 4 mm) was sandwiched between two circular plates (which are first and second cover plates of the negative electrode current collector, and each have a diameter of 8 mm, and a thickness of 1 mm). Here, both of the two circular plates and the disc spring were made of brass, and were plated with tin. Moreover, the longitudinal section of the disc spring was trapezoidal.

—Method for Producing AA-size Alkaline Battery—

A positive electrode, a negative electrode, and an alkaline electrolyte were provided in a battery case according to the method described in the first example. Then, the disc spring sandwiched between the two circular plates was arranged above an upper surface of the negative electrode. Here, the disc spring was arranged above the upper surface of the negative electrode such that the outer diameter of the disc spring decreases from the top to the bottom. An assembled sealing body obtained by integrating a sealing plate having a through hole provided with a current collector rod (having a diameter of 1.5 mm, and a length of 1 mm), a negative electrode terminal plate, and an insulating washer was arranged on the circular plate. In this way, the AA-size alkaline battery of the present example was produced.

2. Evaluation of AA-size Alkaline Battery

The AA-size alkaline batteries of the first to fifth examples and a commercially available AA-size alkaline battery (an AA-size alkaline battery of a first comparative example) were discharged in the following two ways.

Discharge Condition (A): the batteries were discharged at a constant current of 100 mA until the voltage reached 0.9 V, and discharge capacity was evaluated. Here, the temperature was 20° C. This is a condition to evaluate so-called low-rate discharge characteristics.

Discharge Condition (B): the batteries were discharged at a constant current of 1000 mA until the voltage reached 0.9 V, and discharge capacity was evaluated. Here, the temperature was 20° C. This is a condition to evaluate so-called high-rate discharge characteristics.

FIG. 11 indicates results of evaluation of AA-size alkaline battery A of the first comparative example and AA-size alkaline batteries B-F of the first to fifth examples. As can be seen in FIG. 11, under both of the discharge conditions (A) and (B), the discharge capacity of the first to fifth examples was larger than that of the first comparative example 1. The reason for this is probably that a current collector having a good current collecting property was used as a negative electrode current collector, so that the active material was more effectively discharged. That is, this is probably because in the first to fifth examples, even when the negative electrode is deformed due to discharge, contact between the negative electrode and the negative electrode current collector can be maintained, which can maintain the current collecting property at the negative electrode, so that the active material can be discharged more efficiently.

### INDUSTRIAL APPLICABILITY

As described above, in the present invention, even when the negative electrode is deformed due to discharge, contact between the negative electrode and the negative electrode current collector can be maintained. Therefore, the present invention is applicable to alkaline batteries requiring improved discharge characteristics or long life.

### DESCRIPTION OF REFERENCE CHARACTERS

1 Battery Case
3 Positive Electrode
4 Separator
6 Negative Electrode
6a Hollow Part
7 Sealing Plate
7a Through Hole
10 Assembled Sealing Body
20 Negative Electrode Current Collector
21 Main Body
22 Retainer
23 Pressure Contact Part
30 Assembled Sealing Body
40 Negative Electrode Current Collector
41 Main Body
42 Inclined Member
42a Upper End
42b Lower End
50 Assembled Sealing Body
60 Negative Electrode Current Collector
61 Main Body
62 Raised/Recessed Part
70 Assembled Sealing Body
80 Negative Electrode Current Collector
81 First Cover Plate (Cover Plate)
82 Spring Body
83 Second Cover Plate (Pressure Member)
84 Current Collector Rod

1. An alkaline battery comprising:
a positive electrode in a battery case;
a negative electrode inside the positive electrode;
a separator between the positive electrode and the negative electrode;
a negative electrode current collector; and
an alkaline electrolyte, wherein
the negative electrode is a wound porous sheet containing zinc, and has a hollow part extending in a longitudinal direction of the battery case,
the negative electrode current collector includes
a main body which is in the shape of a rod, and is disposed in the hollow part such that an axial direction of the main body is parallel to a longitudinal direction of the hollow part, and
a retainer disposed between portions of the negative electrode which are adjacent to each other in a radial direction of the negative electrode, the retainer being connected to the main body, and
the main body and the retainer sandwich a portion of the negative electrode which is present between the main body and the retainer.

2. The alkaline battery of claim 1, wherein
the negative electrode current collector includes a pressure contact part at which the retainer is pressure contacted to the main body.

3. The alkaline battery of claim 1, wherein
the retainer is disposed between an innermost circumference portion and a next innermost circumference portion of the negative electrode, and
the main body and the retainer sandwich an end part of the innermost circumference portion in a circumferential direction of the negative electrode.

4. An alkaline battery comprising:
a positive electrode in a battery case;
a negative electrode inside the positive electrode;
a separator between the positive electrode and the negative electrode;
a negative electrode current collector; and
an alkaline electrolyte, wherein
the negative electrode is a wound porous sheet containing zinc, and has a hollow part extending in a longitudinal direction of the battery case, and
the negative electrode current collector includes
a main body which is in the shape of a rod, and is disposed in the hollow part such that an axial direction of the main body is parallel to a longitudinal direction of the hollow part, and
an inclined member inclined relative to the axial direction of the main body, one end of the inclined member being connected to the main body, and the other end of the inclined member being disposed in the negative electrode.

5. The alkaline battery of claim 4, wherein
the inclined member of the negative electrode current collector includes two or more and seven or less inclined members.

6. An alkaline battery comprising:
a positive electrode in a battery case;
a negative electrode inside the positive electrode;
a separator between the positive electrode and the negative electrode;
a negative electrode current collector; and
an alkaline electrolyte, wherein
the negative electrode is a wound porous sheet containing zinc, and has a hollow part extending in a longitudinal direction of the battery case,
the negative electrode current collector includes a main body which is in the shape of a rod, and has a side surface provided with a raised/recessed part, and
the negative electrode current collector is disposed in the hollow part such that an axial direction of the main body is parallel to a longitudinal direction of the hollow part.

7. The alkaline battery of claim 6, wherein
the raised/recessed part is formed in a helical pattern relative to the axial direction of the main body.

8. An alkaline battery comprising:
a positive electrode in a battery case;
a negative electrode inside the positive electrode;
a separator between the positive electrode and the negative electrode;
a negative electrode current collector; and
an alkaline electrolyte, wherein
the negative electrode is a wound porous sheet containing zinc, and
the negative electrode current collector includes a cover plate covering one end surface of the negative electrode, and a pressure member pressing the cover plate against the end surface of the negative electrode via a spring body.

9. The alkaline battery of claim 8, wherein
the spring body is a disc spring having an outer diameter that decreases toward the cover plate.

10. The alkaline battery of claim 1, wherein
1.0≦x/y≦1.5, where total mass of the alkaline electrolyte in the battery case is x [g], and mass of the zinc in the negative electrode is y [g].

11. The alkaline battery of claim 1, wherein
the positive electrode contains manganese dioxide as an active material, and
0.9≦(capacity of the negative electrode/capacity of the positive electrode)≦1.1, where the capacity of the positive electrode is calculated on a condition that the manganese dioxide has a theoretical capacity of 308 mAh/g, and the capacity of the negative electrode is calculated on a condition that the zinc has a theoretical capacity of 820 mAh/g.

12. The alkaline battery of claim 4, wherein
1.0≦x/y≦1.5, where total mass of the alkaline electrolyte in the battery case is x [g], and mass of the zinc in the negative electrode is y [g].

13. The alkaline battery of claim 6, wherein
1.0≦x/y≦1.5, where total mass of the alkaline electrolyte in the battery case is x [g], and mass of the zinc in the negative electrode is y [g].

14. The alkaline battery of claim 8, wherein
1.0≦x/y≦1.5, where total mass of the alkaline electrolyte in the battery case is x [g], and mass of the zinc in the negative electrode is y [g].

15. The alkaline battery of claim 4, wherein
the positive electrode contains manganese dioxide as an active material, and
0.9≦(capacity of the negative electrode/capacity of the positive electrode)≦1.1, where the capacity of the positive electrode is calculated on a condition that the manganese dioxide has a theoretical capacity of 308 mAh/g, and the capacity of the negative electrode is calculated on a condition that the zinc has a theoretical capacity of 820 mAh/g.

16. The alkaline battery of claim 6, wherein
the positive electrode contains manganese dioxide as an active material, and
0.9≦(capacity of the negative electrode/capacity of the positive electrode)≦1.1, where the capacity of the positive electrode is calculated on a condition that the manganese dioxide has a theoretical capacity of 308 mAh/g, and the capacity of the negative electrode is calculated on a condition that the zinc has a theoretical capacity of 820 mAh/g.

17. The alkaline battery of claim 8, wherein
the positive electrode contains manganese dioxide as an active material, and
0.9≦(capacity of the negative electrode/capacity of the positive electrode)≦1.1, where the capacity of the positive electrode is calculated on a condition that the manganese dioxide has a theoretical capacity of 308 mAh/g, and the capacity of the negative electrode is calculated on a condition that the zinc has a theoretical capacity of 820 mAh/g.
